(19) United States
(12) Patent Application Publication
(10) Pub. No.: US 2024/0298819 A1
(43) Pub. Date: Sep. 12, 2024

(54) MIRROR DEVICE WITH NIGHT LIGHT MODE, MIRROR DEVICE WITH CAPACITIVE SENSOR, AND MIRROR DEVICE WITH INTERFERENCE-OPTICAL COATING

(71) Applicant: Sidler Metallwaren AG, Romanshorn (CH)

(72) Inventor: Thomas GERIG, Burgdorf (CH)

(73) Assignee: Sidler Metallwaren AG, Romanshorn (CH)

(21) Appl. No.: 18/263,964

(22) PCT Filed: Jan. 31, 2022
(86) PCT No.: PCT/EP2022/052197

§ 371 Date: Aug. 2, 2023

(30) Foreign Application Priority Data
Feb. 9, 2021 (EP) 21156030.5

(51) Int. Cl. A47G 1/02; F21V 7/00; F21V 23/00; F21V 23/04; F21W 131/302; F21Y 105/00; F21Y 113/10; H05B 47/115; H05B 47/175

(52) U.S. Cl. CPC A47G 1/02; F21V 7/0008; F21V 23/008; F21V 23/0471; H05B 47/115; H05B 47/196; A47G 2200/08; F21W 2131/302; F21Y 2105/00; F21Y 2113/10

(57) ABSTRACT

The invention relates to a mirror device (101) having a mirror surface (1), at least one light source (2), a control device (3), and first and second control elements (4, 18) connected to the control device (3) via a cable. The light source (2) is operable by the first and second control elements (4, 18). By means of the first control element (4), a first illumination mode (5) of the light source (2) can be switched on and off. By means of the second control element (18), a second illumination mode (6) of the light source (2) can be switched on and off. The first illumination mode (5) is a night light mode and in particular has a lower blue light component than the second illumination mode (6). The first illumination mode (5) differs from the second illumination mode (6).

### FIELD OF THE INVENTION

The present inventions relate to a mirror device.

### BACKGROUND OF THE INVENTION

A conventional mirror device according to the state of the art comprises a mirror surface with lighting, which can often be operated by a user on the mirror device or control elements provided therefor. However, the lighting of this mirror device is designed to provide a bright light and to allow a user to view himself well in the mirror device. A disadvantage is that this lighting causes a user to be very much awakened at night by the light, which is suitable for daylight conditions, because melatonin production is inhibited and cortisol release is promoted. Another disadvantage is the poor lighting in an area close to the mirror surface, as this area is in the shadow of the lighting elements located behind the mirror surface.

### SUMMARY OF THE INVENTION

The task of the invention is to avoid the disadvantages of the prior art and in particular to provide a particularly good illumination directly in front of the mirror surface for a user. In addition, the use of the mirror device is to be improved for a user by a better illumination in the use area in front of the mirror surface, in particular for small distances of the user relative to the mirror surface.

The task is solved by the independent claim (s).

The task is solved in particular by a mirror device comprising a mirror surface with a viewing area and an illumination area and at least one light source, preferably an LED light source. The at least one light source is arranged behind the illumination area of the mirror surface. The viewing area is substantially opaque to the area behind the mirror surface.

The illumination area comprises an inner surface and an outer side. The inner surface is arranged on the side of the illumination area facing the light source and the outer side is formed on the side facing away from the light source. A main axis of a light beam of the light source is oriented at an angle of 3° to 89°, in particular at an angle of 45° to 87°, more preferably 75° to 85°, relative to a mirror plane of the mirror surface, preferably oriented toward the viewing area.

The main axis of the light beam is defined as the axis of the averaged vectorial orientation of the light beams of the light beam. Such an inclined major axis of the light beam of the light source increases the brightness immediately in front of the viewing surface.

The main axis of the light beam of the light source can be aligned at an angle to the mirror plane by aligning the light source and/or aligned at an angle to the mirror plane by an optical device such as lenses and/or mirrors. This has the advantage that the arrangement of the light source can be optimized in combination with the illumination in the area in front of the viewing area.

The mirror plane designates a front side of the mirror surface facing the user and forms a two-dimensional plane.

The illumination area may have an optical grind on the inner surface. The optical grind may extend adjacent to the viewing area to an outer edge of the mirror surface.

The optical grind can be formed by shaping during fabrication, material recessing, etching, and/or grinding the inner surface of the illumination area.

The optical grind can at least partially form a recess perpendicular to the mirror plane so that the light beams of the light beam can be refracted toward the viewing area.

Preferably, the light source can be located immediately behind the optical grind, allowing for a smaller width of the mirror device.

The optical grind may be located in a partial area at the edge of the mirror surface, or may extend intermittently or completely circumferentially along the edge of the mirror surface.

Several optical grinds can be successively arranged between the viewing area and the edge.

The outer side of the viewing area and/or illumination area may form a substantially flat two-dimensional plane.

The optical grind may have a length from the viewing area to the edge of the illumination area of 0.1 cm to 8 cm, especially 1 cm to 5 cm, more preferably 1.5 cm to 2.5 cm.

The outer edge of the mirror device can have a width of at least 2 mm, especially 1 mm, so that there is no sharp or easily breakable edge.

The optical grind may have a faceted-grind shape and/or

a smooth-grind shape.

A faceted shape is particularly easy to manufacture and also allows the light source to be located closer to the inner surface of the illumination area and better placed at an angle to the mirror plane.

The faceted shape may have an angle relative to an axis of the viewing area of the mirror surface of 3° to 75°, particularly 4° to 50°, more preferably 5° to 25°.

A smooth-ground shape can focus light on the area near the front of the viewing area, similar to a convex lens, improving the use of the mirror device.

Such optical grinds enable higher brightness in an area close in front of the viewing area on the side facing the user. Thus, the use of the mirror device for, among other things, cosmetic purposes is improved for users.

It is therefore the object of the present invention to prevent the disadvantages of the prior art and, in particular, to provide a mirror device and a method of making such a mirror device which give the user a simple, uncomplicated means of using the mirror cabinet light even at night.

The task of a further aspect of the invention is solved by a mirror device, preferably a mirror device described above, comprising a mirror surface, at least one light source, preferably an LED light source, a control device connected to the light source, and a first control element and a second control element. The first and second control elements are connected to the control device via a cable. The light source is operable by the first control element and the second control element, preferably a dual switch. The first illumination mode of the light source is switchable on and off by the first control element. The second illumination mode of the light source is switchable on and off by the second control element. The first illumination mode is a night light mode, in particular having a lower blue light content than the second illumination mode, and the first illumination mode is different from the second illumination mode.

This mirror device enables simple and intuitive operation for users via the control elements. Furthermore, various control elements such as motion detectors, magnetic switches, inductive switches and mechanical or optical switches are conceivable as control elements.

Especially at night, many people are particularly sensitive to bright, blue light, which is known to make users especially awake. Furthermore, bright and especially blue light is known to affect people's sleep-wake rhythm and lead to reduced melatonin production.

A high proportion of blue in light is therefore often blamed for leading to sleep disorders.

A first and second illumination mode allows a user to choose between the first and second illumination mode depending on personal feeling and/or time of day. Especially at night, when going to the bathroom, a less blue light compared to the second illumination mode can enable the user to fall asleep better.

In this context, blue light refers to light with a wavelength in the range from 450 nm to 530 nm. In this context, it is conceivable to minimize the blue light of the light source but to retain at least part of the violet spectrum from 380 nm to 450 nm. The reduction of the blue light component in the light, can be done by the light generation by the light source and/or use of filter devices.

The light source can include any suitable type of light source, such as fluorescent tubes, halogen bulbs, LEDs, and OLEDs. Preferably, however, LEDs are used because LEDs are particularly well suited for lighting and coloring to create different moods.

A cable connection of the first and second control elements to the control device facilitates installation, since such cable connections are already widely available in houses and/or apartments. Therefore, installation of the mirror device in a plurality of houses and/or apartments is easily possible. In addition, a cable connection enables high reliability.

Furthermore, the mirror device can be used very flexibly. In this context, it would be conceivable to design various other light sources, such as ceiling lights, so that they can also be connected to the control device of the mirror device.

The mirror surface of the mirror device may comprise a mirror coating and a glass layer and, in particular, a protective layer. The glass layer is preferably a white glass, but tinted or colored glass is also conceivable.

Depending on the intended use, various preset lighting modes and combinations of color temperature and/or light intensity for the light sources are also conceivable. For example, a bright work light, a make-up light, a bath light and/or a night mode could be provided as illumination modes.

The mirror device control device may include an operating element for adjusting the intensity and/or color temperature of the light source of the first illumination mode and/or second illumination mode.

The operating element can be arranged behind the removable mirror surface and can preferably comprise a rotary switch.

A removable mirror surface refers to a mirror surface that is designed to be at least partially removable, movable, rotatable and/or pivotable. Thus, the operating element is designed to be accessible, but not accessible for everyday use but for initial adjustment. After adjustment, the operating element is invisible in everyday use because it is arranged behind the mirror surface.

This operating element has the advantage that users can adapt the mirror device to their needs and premises. For small rooms, even low brightness could be sufficient, while large rooms require high brightness to ensure good visibility.

Preferably, the color temperature is adjusted using an operating element of the mirror device so that a user can easily make these adjustments.

Two or more operating elements may be formed.

In a preferred embodiment, the illumination mode and/or the light source, which is in the switched-on state, can be set directly during operation using the rotary switches in terms of brightness and/or color temperature. Thus, a user can directly see which setting is preferred and an intuitive operation can be performed. Thus, in this embodiment, only two operating elements are required to adjust the color temperature and/or brightness of all lighting modes and/or light sources.

In addition, a control device may be adapted to store the set brightness and/or color temperature from one light source or a plurality of light sources and to use the values of the last settings of the light source when used again.

In this context, it would also be conceivable to store preferred settings for different lighting conditions. In particular, different color settings of the light source would be conceivable.

The preferred arrangement of the operating element behind the mirror surface has on the one hand aesthetic reasons, but also offers the advantage that the operating element is not easily accessible. In this context, other concealed mounting of the operating element, such as on/in the sides of the mirror device, is also conceivable.

Once the preferred settings have been found, it is not necessary for many users to continue accessing the operating element. This prevents unintentional or accidental adjustment by the user or other persons.

An operating element in the form of a rotary switch can be easily operated and provides good fine adjustment options through haptic feedback. In a preferred design, the rotary switches are slots.

A slot reinforces the previously described inaccessibility, as a coin or tool is required for a control change to be made and no inadvertent or accidental adjustment can be made.

The color temperature of the light source can preferably be regulated in a range from 500 K to 10000 K.

The color temperature has different effects on the state of mind of users. Many users find a low color temperature relaxing and pleasant, while a high color temperature is often perceived as promoting concentration. It is therefore advantageous to allow the user to regulate a wide range of color temperatures, so that the color temperature can be adapted to the respective preferences.

In addition, the light source has as continuous a color spectrum as possible, so that a high color rendering index can be achieved and natural light with as continuous a spectrum as possible can be ensured.

Indirect illumination can preferably be generated by the light source of the mirror device. In particular, the indirect illumination is used as a light source in the first illumination mode.

Indirect light is often perceived as more pleasant by users. In addition, with indirect light, significantly less light reaches a user with the same intensity of the light source, since the light is scattered and/or reflected beforehand. Thus, it can additionally be made possible that the user is not exposed to bright light. Especially in the first illumination mode of the light source, it can thus be ensured that the user can easily perceive the surroundings around the light source despite a low brightness of the light source.

To provide indirect light, one or more light sources may be located on the rear wall and/or on/in the mirror device. In addition, the light source or sources may be arranged in a recessed position on the mirror device, or below or above the mirror device with an offset to the rear so that substantially no direct light reaches a user when the user is in front of the mirror surface.

However, when indirect light is used, details are more difficult to see visually. Therefore, in a preferred embodiment, additional light sources are provided that can be switched on as needed to produce direct light.

The light source of the mirror device may have a color temperature of 2600 K or less in the first illumination mode.

The color temperature in the first illumination mode is thus preferably below the color temperature of a conventional incandescent lamp. Thus, a user is enabled to avoid a high blue light component by the first illumination mode of the light source.

It also ensures that the blue light component can be used as a night light mode in any setting of the first illumination mode.

The mirror device is preferably switchable on and off in the first illumination mode by the first control element of a first light source, and switchable on and off in the second illumination mode by the second control element of a second light source.

A first and second light source of the mirror device are advantageous, as the light sources can thus be optimally arranged at different locations for their intended use.

In this context, the brightest possible illumination in a large area, even at the eye level of a user, would be conceivable in the second illumination mode.

In addition, the choice of light source and the adjustment options provided by the operating element, in particular the range of color temperature and/or intensity, can be optimally adapted to the light source in question.

The first light source of the first illumination mode of the mirror device is preferably arranged on the underside of the mirror device.

Placing the first light source of the first illumination mode on the underside of the mirror device when properly mounted is advantageous because it is indirect light. This allows a user to have good visibility of the environment around the mirror device with minimal luminosity of the first light source.

The mirror device may comprise a cabinet body and the mirror surface may be arranged to be at least partially movable.

A mirror device with a cabinet body provides storage space inside and, at the same time, an advantageous arrangement of the light source or light sources for generating preferably indirect light. Thus, the mirror device can be used particularly as a bathroom cabinet.

In the bathroom, a night light mode is especially beneficial to stay tired when going to the toilet at night and not be woken up too much.

The cabinet body is preferably cuboid-shaped, but other geometric shapes are also conceivable.

An at least partially movable mirror surface also ensures easy access to the operating element and the storage space inside the cabinet body. In addition, a mirror surface can also be arranged on the other side of the mirror surface so that a user can also use the interior mirror as a mirror when the cabinet body is open.

The task is further solved by a method for manufacturing such a mirror device comprising the following step:

connection of the first control element and the second control element to the control device via a cable, so that at least one light source can be switched on and off by the first control element and by the second control element.

A method for manufacturing such a mirror device is easy to perform for an electrician and/or private persons, since the cables for connecting the control elements to the control device are often already laid in the wall. The mirror device can be connected to the mains supply with 100 V to 280 V and preferably does not require any additional laying of cables.

The first and second control elements are preferably located near the door to the room with the mirror device. The mirror device may include a transformer. Thus, the cable between the control element and the control device can be powered by a power supply with a voltage of 100 V to 280 V before the voltage in the transformer is reduced to the usual 12 V to 48 V for the light sources.

The operation and adjustment of the intensity of a light source of a mirror device is often cumbersome and only adjustable by a user at some distance without simultaneous adjustment of the light color intensity. Therefore, a mirror device should have a way to adjust the light source that allows easy and intuitive operation directly on the mirror device.

It is therefore the task of a further aspect of the invention to avoid these disadvantages of the prior art and, in particular, to create a mirror device that can be adjusted by the user on site as desired.

In particular, this is solved by a mirror device, preferably a mirror device as described above, which comprises a mirror surface, a control device, and a light source. A capacitive sensor is designed in such a way that the intensity and/or color temperature of the light source can be controlled in such a way that the light intensity and/or color temperature can be adjusted by the proximity and/or touch of a user.

Such a capacitive sensor allows intuitive adjustment of the intensity of the light source by a user in the form of a proximity and/or touch, directly on the mirror device, without compromising the aesthetics of the mirror device by an additional visible switch.

The capacitive sensor can be used to generate one or more electric fields, so that a single-stage or multi-stage setting can be achieved.

In a preferred embodiment, the capacitive sensor is arranged such that a user can adjust the intensity along a straight, arcuate, and/or circular motion. Moreover, the light source is not only adjustable by the proximity and/or touch, but also switchable on and off, wherein the minimum of the intensity of the light source is preferably arranged on one side of the proximity/touch field of the capacitive sensor and the maximum of the intensity of the light source is arranged on the other side.

The adjustment of the light source's intensity by the capacitive sensor through proximity, for example a gesture of the user at some distance from the capacitive sensor, allows easy handling. In darkness, operating elements for light sources are often difficult to make out. It is therefore advantageous if the control by proximity can be performed by a gesture in an area, preferably near an edge and/or marked surface, to switch on and/or adjust the light source.

The distance when approaching the capacitive sensor, which leads to the light source being switched on and off, is preferably in a range of 0-10 cm, in particular 0 to 6 cm. The adjustment of the light intensity is preferably nevertheless to be carried out by touching the sensor.

Furthermore, if the light intensity can be adjusted by touching the capacitive sensor, it is conceivable to touch the corresponding location of the sensor, by which the light can be turned on and at the same time the intensity is adjusted by selecting the corresponding location of the sensor.

In contrast to rotary switches for dimming the intensity of light sources, such a capacitive sensor offers the advantage that the light source can be switched on and off and dimmed by touch. Thus, a user can very quickly and intuitively adjust the intensity of the light source to his needs in one movement.

The capacitive sensor of the mirror device is preferably arranged behind the mirror surface, in particular on/in an edge of the mirror device, in particular preferably on/in a lateral edge of the mirror device when the mirror device is properly attached. The capacitive sensor may further be arranged on the cabinet body.

Mounting the capacitive sensor of the mirror device on/in an edge of the mirror device is advantageous for several reasons.

On the one hand, the capacitive sensor is thus very easy to use because an edge provides a user with an additional haptic perception.

Furthermore, the capacitive sensor can thus be operated directly on the mirror device. Thus, the light source can be controlled at the point where it is used. Direct visual feedback thus makes it easier for a user to make the preferred settings for the light source.

The lateral edges of the mirror device are particularly well suited for arranging the capacitive sensor on/in them, since a mirror device is usually aligned with the center of the body and/or the head. Thus, easy accessibility to the capacitive sensor for adjusting the light source is possible while a user is in front of the mirror device.

The capacitive sensor of the mirror device can be arranged below the mirror surface, such that the capacitive sensor is controllable by a proximity and/or touch of a user on the mirror surface. The mirror surface preferably has a recess below which the capacitive sensor is arranged. Here, below the mirror surface means behind the mirror surface as seen by a user.

Placing a capacitive sensor below the mirror surface is advantageous because a user faces the mirror surface while using a mirror device. Thus, the user can easily perform a proximity and/or touch of the capacitive sensor.

The area of the mirror surface is preferably made identifiable for easier operation by a user. The area of the mirror surface above the capacitive sensor can be identified by a recess in the mirror surface, a marking, and/or by treatment of the mirror surface, such as sandblasting.

The problem is further solved by a method of manufacturing such a mirror device comprises the following step:

Establishing a connection of a capacitive sensor to the light source such that the intensity of the light source is adjustable by the proximity and/or touch of a user.

Such a method allows easy adjustment of the light source by a user at the mirror device. In addition, a connection of the light source and capacitive sensor via the control device is preferred so that installation is facilitated and adjustments can be made.

The mirror device is often used for a variety of purposes. In particular, for certain uses by a user, such as for make-up or for use as a work light, the area in front of the mirror surface should be very well illuminated so that details are clearly visible visually.

Previous mirror devices allow the creation of a bright light, but there are always shadows on the face, which prevent a natural impression of a face in the mirror device.

According to a further aspect of the invention, it is therefore a task to prevent these disadvantages of the prior art and, in particular, to create a mirror cabinet device that enables a natural mirror image.

The task is solved by a mirror device, in particular as previously described, comprising a light source and a mirror surface. The mirror surface comprises a viewing area and an illumination area. The light source is arranged behind the illumination area of the mirror surface. The viewing area is substantially opaque to the area behind the mirror surface. The illumination area includes an inner surface and an outer side. The inner surface is arranged on the side facing the light source and the outer side is arranged on the side facing away from the light source. The inner surface comprises an interference optical coating.

The interference optical coating is designed in such a way that it has a reflective effect if the brightness in the room is greater than behind the mirror surface, i.e. when the light source in the illumination area is switched off. As soon as the light source in the illumination area is switched on, the coating is translucent. The interference optical coating is preferably not 100% reflective.

Such a mirror device offers the advantage that the complete mirror surface, including the illumination area, appears mirror-like due to the interference optical coating when the light source is switched off.

The visibility of the light source behind the illumination area to users depends on the brightness ratio on both sides of the illumination area. Thus, the interference optical coating makes the illumination area essentially a reflective surface to a user when the light source is off and translucent when the light source is on.

The light source can be switched on when the user needs it. Since the light source is located behind the illumination area, the light source faces the user and provides good illumination. In addition, the viewing area can still be used by the user because it is opaque.

The properties of the interference optical coating determine the transmission and reflection of the illumination area. The coating thickness and the choice of material for the interference optical coating can thus influence the transmission and reflection. A suitable material is chromium, but other materials, especially metals such as silver, stainless steel and copper, are also conceivable.

The illumination area of the mirror device preferably has a diffuser surface, preferably on the outer side of the illumination area.

The diffuser surface results in diffuse and homogeneous scattering and/or reflection of light essentially without light loss. Here, the diffuser surface can be deliberately structured and/or frosted and/or etched. In addition, it is conceivable that the diffuser surface is printed or glued as a separate layer onto the outer side of the illumination area. Etching can be achieved with foam or liquid etchant.

The diffuser surface can have cavities, in particular concave structures, which are preferably non-uniform, in particular preferably randomly distributed. Such a diffuser surface results in soft, bright and shadow-free illumination.

Such concave structures result in optimal diffusion and homogenization of light and thus little loss of light and few shadows cast on the face.

In this context, the concave structures do not necessarily have to have optimum curvatures, but can also have unevenness in the curvature, such as is produced by etching with liquid etchant. In the context of the application, non-uniform means that the concave structures are formed to different depths and sizes. Preferably, the concave structures have edges between them that are bounded by corners. In particular, more than six, preferably seven corners may be formed per cavity. The concave structures are preferably etched into a glass, in particular applied to the surface of the glass by an etching foam. This results in a frosted glass surface with concave structures that ensures optimum diffusion of light.

The cavities preferably have maximum expansions of essentially 200 μm, wherein the minimum expansion is 10 μm, in particular 20 μm further in particular 40 μm. The depth of the cavities is preferably in the range of 5-30 μm, preferably 3-10 μm.

The distance between the interference optical coating on the inner side of the illumination area and the diffuser surface on the outer side of the illumination area is preferably less than 1 cm, in particular preferably less than 0.5 cm.

For minimized shadowing and optimal illumination, an arrangement at least partially surrounding the viewing area is conceivable.

In combination with the setting of the intensity and/or color temperature of the light source, it is thus possible to simulate different lighting situations and thus, for example, to check how a makeup design ultimately looks in warmer light.

To solve the problem further performs a method of manufacturing a mirror device as previously described comprising:

The application of the interference optical coating on the inner surface of the illumination area and preferably

The creation of the diffuser surface on the outer side of the illumination area.

Previous mirror devices do not allow direct illumination without casting shadows. Uniform illumination is not possible, especially when the distance to the mirror surface is small.

It is therefore a task of the invention to create a mirror device that avoids the disadvantages of the prior art and, in particular, to create a mirror device that provides uniform, shadow-free illumination, even with direct light.

The task is solved by a mirror device, in particular as previously described, comprising a light source and a mirror surface. The mirror surface comprises a viewing area and an illumination area. The light source is arranged behind the illumination area of the mirror surface. The viewing area is substantially opaque to the area behind the mirror surface. The illumination area includes an inner surface and an outer surface. The inner surface is arranged on the side facing the light source and the outer side is arranged on the side facing away from the light source. The outer side comprises a diffuser surface.

Such a mirror device enables shadow-free illumination of an object or person located in front of the mirror device.

The diffuser surface results in diffuse and homogeneous scattering and/or reflection of light essentially without light loss. Here, the diffuser surface can be deliberately structured and/or frosted and/or etched. In addition, it is conceivable that the diffuser surface is printed or glued onto the outer side of the illumination area as a separate layer.

Etching can be achieved with foam or liquid etchant.

The diffuser surface can have cavities, in particular concave structures, which are preferably non-uniform, in particular preferably randomly distributed.

Such a diffuser surface results in soft, bright and shadow-free illumination.

Such concave structures result in optimal diffusion and homogenization of light and thus little loss of light and few shadows cast on the face.

In this context, the concave structures do not necessarily have to have optimum curvatures, but can also have unevenness in the curvature, such as is produced by etching with liquid etchant. In the context of the application, non-uniform means that the concave structures are formed to different depths and sizes. Preferably, the concave structures have edges between them that are bounded by corners. In particular, more than six, preferably seven corners may be formed per cavity. The concave structures are preferably etched into a glass, in particular applied to the surface of the glass by an etching foam. This results in a frosted glass surface with concave structures that ensures optimum diffusion of light.

The cavities preferably have maximum expansions of essentially 200 μm, wherein the minimum expansion is 10 μm, in particular 20 μm further in particular 40 μm. The depth of the cavities is preferably in the range of 5-30 μm, preferably 3-10 μm.

### BRIEF DESCRIPTION OF THE DRAWINGS

In the following, the inventions are illuminated in more detail by means of figures. Here shows:

FIG. 1: An embodiment of a mirror device;

FIGS. 2 to 13: Different embodiments of the mirror surface of the mirror device;

FIGS. 14 to 16: Different embodiments of the mirror device with arrangement of the light source or light sources;

FIG. 17: A cross-section of a first embodiment of the mirror surface;

FIG. 18: A cross-section of a second embodiment of the mirror surface;

FIG. 19: A cross-section of a third embodiment of the mirror surface;

FIG. 20: A cross-section of a first embodiment of a mirror surface of the mirror device on both sides;

FIG. 21: A cross-section of a second embodiment of the double-sided mirror surface;

FIG. 22: A cross-section of a third embodiment of the double-sided mirror surface;

FIGS. 23 and 24: microscopic images of a diffuser surface;

FIG. 25: a schematic double refraction of a light beam at an illumination area of a mirror device in cross section;

FIGS. 26 and 27: Cross-sections of two embodiments of the mirror device having an optical grind on an inner surface of an illumination area;

FIGS. 28 and 29: Cross-sections of the two versions of the mirror device shown in FIG. 26 and FIG. 27 with a schematic light beam of a light beam.

### DETAILED DESCRIPTION OF THE PREFERRED EMBODIMENTS

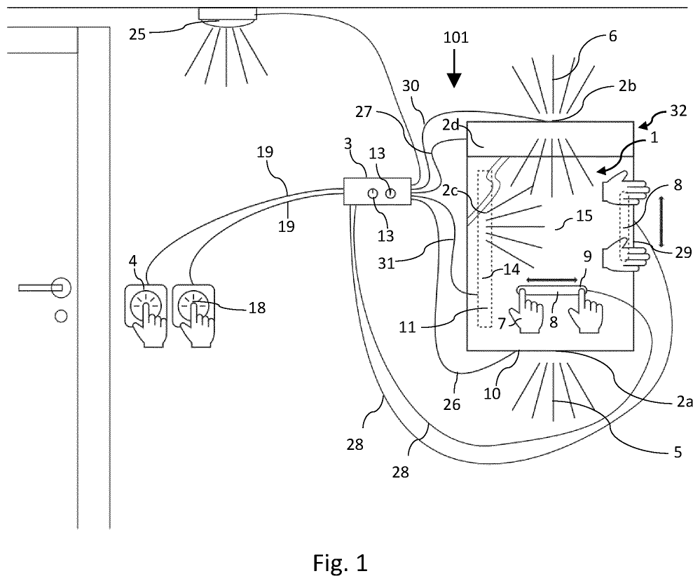

FIG. 1 shows a schematic representation of an embodiment of the mirror device 101 comprising a control device 3 and a cabinet body 32. This control device 3 connects a first control element 4 and a second control element 18 to a first light source 2a and a second light source 2b, so that both can be switched on and off by the control elements 4, 18.

The light sources 2a and 2b are arranged on the top and underside 10 of the cabinet body 32 and generate indirect light. The light source 2c is arranged under the mirror surface 1 and the light source 2d is arranged under a cover in the upper part of the mirror surface 1.

Furthermore, additional light sources, such as a ceiling lamp 25, can be connected to the control device 3.

The control device 3 also has operating elements 13 which allow the intensity of the first light sources to be adjusted to the needs of a user and/or premises. Preferably, the switched-on light source and/or illumination mode 5, 6 is always adjustable with respect to color temperature and/or brightness.

For better clarity, the control device 3 has been shown outside the cabinet body 32 in this embodiment. In a preferred embodiment, however, the control device 3 is mounted below the mirror surface 1 of the cabinet body 32 or at least outside the field of view of a user. In addition, the operating elements 13 of the control device 3 are designed as rotatable penny slots.

Switching on and off the first light source 2a by the first control element 4 leads to switching on and off the first illumination mode 5, which has a lower blue light component. This first illumination mode is a night light mode, since it provides enough light for the user 7 to be able to orient himself due to the lower blue light component than the second illumination mode 6. The first illumination mode 5 of the first light source 2a has a color temperature of 2600 K at the most.

The second illumination mode 6 of the second light source 2b is intended for use during the day and has a higher blue light content.

The cabinet body 32 is cuboidal in shape, wherein the cabinet body 32 is provided an attachment to a wall with one side. The side of the cabinet body 32 of the mirror surface 1, when properly attached, faces away from the wall and faces the user 7. The side of the cabinet body 32 having the mirror surface 1 is also pivotable, so that the cabinet body 32 can be used for storing objects.

The illumination by the first light source 2a and second light source 2b produces indirect illumination. The light sources 2a, 2b face away from the user 7 so that the user 7 is not dazzled by the first and second illumination modes 5, 6.

The light sources 2c, 2d face the user and can be controlled by the capacitive sensor for optimal illumination.

All light sources 2a, 2b, 2c, 2d and capacitive sensors 8 of the mirror device 101 are connected to the control device 3 via cables 19, 26, 27, 28, 30, 31.

The cabinet body 32 also has a capacitive sensor 8 in a lateral edge 29 and on the mirror surface 1. This capacitive sensor 8 can be controlled by a touch of a user 7, by the user 7 moving his hand along the lateral edge 29. In a linear movement of the hand of the user 7 when touching the capacitive sensor, the intensity of the light sources 2c, 2d can thus be controlled.

The movement in one direction decreases the intensity and leads at the minimum to the switching off of the light sources 2c, 2d. Movement in the other direction increases the intensity of the light sources 2c, 2d and leads to maximum brightness at the maximum.

According to FIG. 1, a user 7 can touch the side of the cabinet body 32 on an edge of the mirror device or on the mirror surface 1. The control by a touch of the mirror surface 1 is performed by a capacitive sensor 8 under the mirror surface, so that the mirror surface appears even. The area of the mirror surface 1 under which the capacitive sensor 8 is located is indicated by a recess 9 in the mirror surface 1.

The mirror surface 1 in FIG. 1 has a viewing area 15 and an illumination area 11. The viewing area 15 is essentially for observing a user's own reflection 7 and is completely opaque.

The illumination area 11 is shown in FIG. 1 as a dashed stripe on the mirror surface 1. The light source 2c is arranged below the illumination area.

The illumination area 11 has an interference optical coating 20 on the inner side 16 (not shown in FIG. 1) and a diffuser surface 14 on the outer side 17, so that the illumination area 11 looks like a mirror surface to a user 7 when the light is switched off. The diffuser surface 14 is made matt by etching and is suitable for strongly diffusing light, so that the area can also be illuminated very close to the mirror surface 1 for shallow angles.

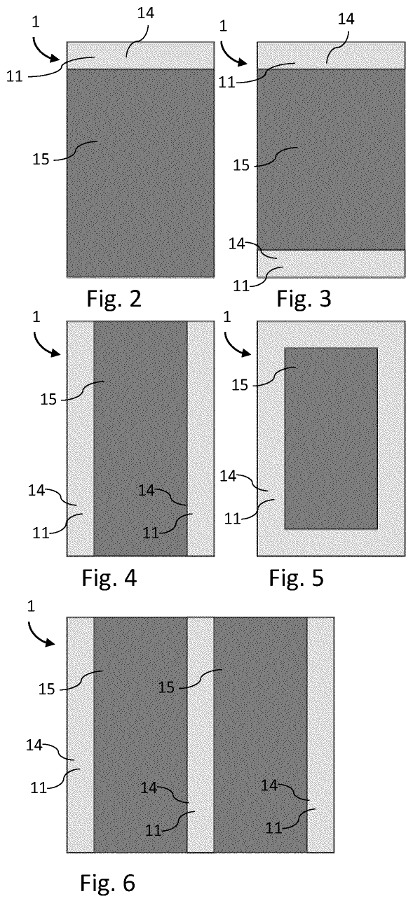

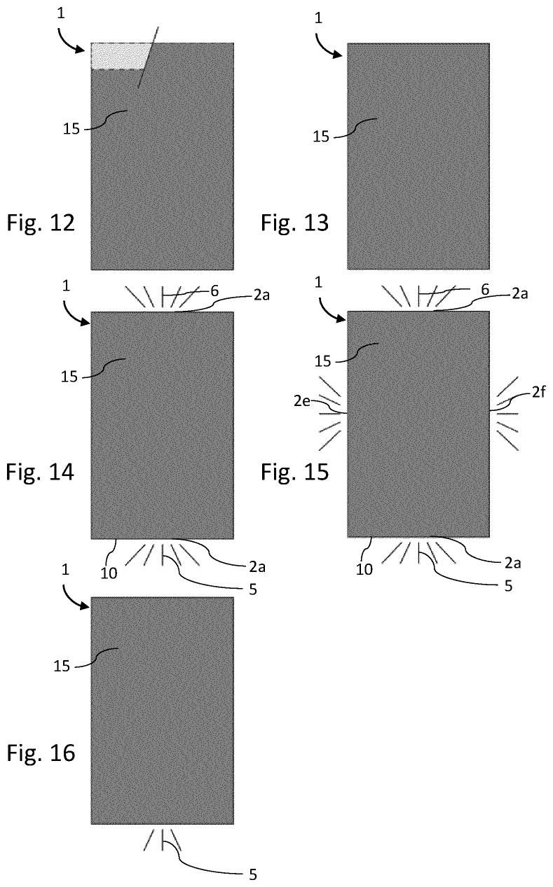

FIGS. 2 to 13 show different embodiments of the arrangement of the illumination area 11 with the diffuser surface 14 and the viewing area 15 of the mirror surface 1. An interference optical coating 20 and further at least one light source 2 are arranged under the illumination area 11 (not shown in the figures).

According to FIGS. 1 to 5, the illumination area 14 is partially arranged at the edge of the mirror surface 1 so that optimum illumination of the viewing area is achieved and the illumination area 11 at least partially surrounds the viewing area 15.

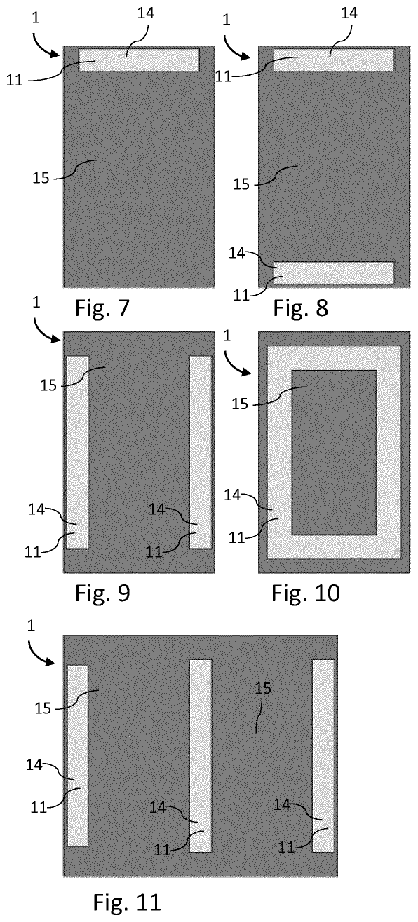

According to the embodiments in FIGS. 7 to 10, the illumination area 11 has a small distance to the edge of the mirror surface 1, so that the illumination area 11 is completely framed by the viewing area 15.

Moreover, as can be seen in the embodiment shown in FIGS. 6 and 11, the illumination area 11 can also be arranged centrally in the mirror surface 1.

FIGS. 14 to 16 show an arrangement of the light sources 2a, 2b, 2e, 2f in the edges of the mirror device 101. The light sources 2a, 2b, 2e, 2f are concealed by the mirror surface 1 and are arranged in a lateral recess substantially orthogonal to the mirror surface 1. The light sources 2a, 2b are suitable for use in first and second illumination modes 5, 6.

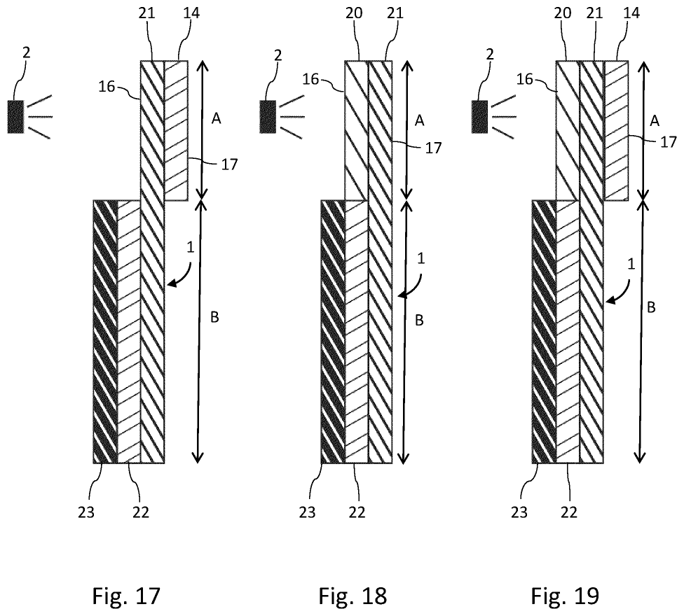

FIG. 17 shows a cross-section of the first embodiment of the mirror surface 1 of the mirror device 101. The light source 2 is arranged behind the cross-sectional area A of the illumination area 11.

A diffuser surface 14 is provided on the outer side 17 of the illumination area 11, which protrudes from the mirror surface 1. However, it would also be conceivable that a region of the glass layer 21 is etched to create a diffuser surface 14.

A glass layer 21 made of white glass is arranged on the inner surface 16 of the cross-sectional area A, which extends completely over the mirror surface 1 over cross-sectional area A and B. The cross-sectional area B of the viewing area 15 has a glass layer 21, a mirror coating 22 and a protective layer 23 from the outside to the inside. The protective layer 23 and mirror coating 22 are opaque.

The glass layer 21 preferably comprises silicon dioxide, but other materials and plastics such as acrylic glass are also conceivable.

FIG. 18 shows a cross-section of the second embodiment of the mirror surface 1 of the mirror device 101 analogous to FIG. 17. The difference to FIG. 17 is that instead of the diffuser surface 14 on the outer side 17, an interference optical coating 20 is arranged on the inner surface 16. The interference optical coating 20 acts like a one-sided mirror, so that when the illumination on the inner surface 16 of the illumination area 11 is low, a user 7 perceives a reflective surface.

FIG. 19 shows a cross-section of the third embodiment of the mirror surface 1 of the mirror device 101 analogous to a combination of FIGS. 17 and 18.

The diffuser surface 14 is arranged on the outer side 17 and the interference optical coating 20 is arranged on the inner side 16 of the cross-sectional area A of the illumination area 11.

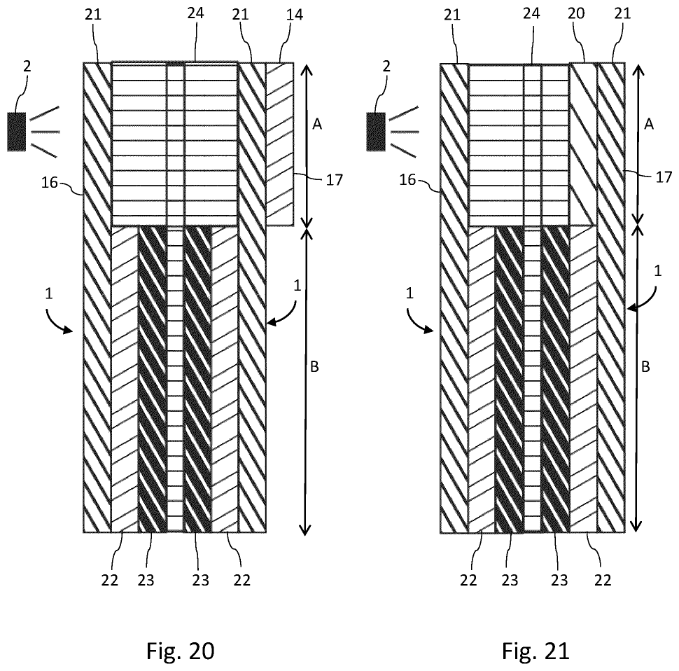

FIG. 20 shows a cross-section of the first embodiment of the mirror surface 1 of the mirror device 101 on both sides.

The cross-sectional area B of the viewing area 15 has a mirror surface 1 on both sides. From the outside to the inside, both sides have a glass layer 21 of white glass, a mirror coating 22 and a protective layer 23. Both protective layers 23 are joined together in the middle by an adhesive layer 24 with liquid adhesive or film adhesive. It would also be conceivable to arrange a common protective layer 23 for both mirror surfaces 1 in the center of the cross section.

The glass layer 21 extends over the cross-sectional area B of the viewing area 15, as well as the cross-sectional area A of the illumination area 11 on both sides 16, 17.

According to FIG. 20, an adhesive layer 24 is arranged between the two glass layers 21. A diffuser surface 14 is attached to the outer side 17 in the cross-sectional area A of the illumination area 11.

FIG. 21 shows a cross-section of the second embodiment of the double-sided mirror surface 1 of the mirror device 101. The figure is analogous to FIG. 21 with the difference that instead of a diffuser surface 14, an interference optical coating 20 is arranged under the glass layer 21 in the cross-sectional area A of the illumination area 11.

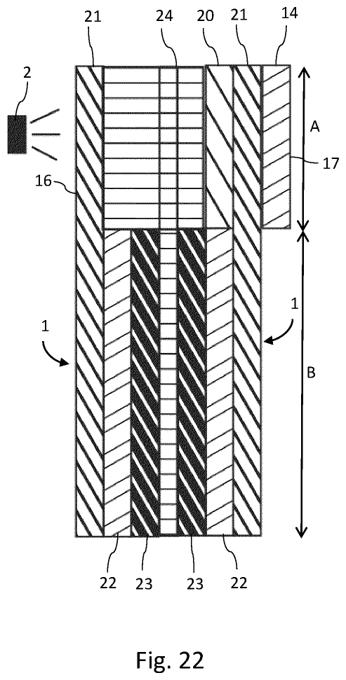

FIG. 22 shows a cross-section of the third embodiment of the double-sided mirror surface 1 of the mirror device 101 analogous to a combination of FIGS. 20 and 21. The diffuser surface 14 is arranged on the outer side 17 and the interference optical coating 20 is arranged behind the glass layer 21 of the cross-sectional area A of the illumination area 11.

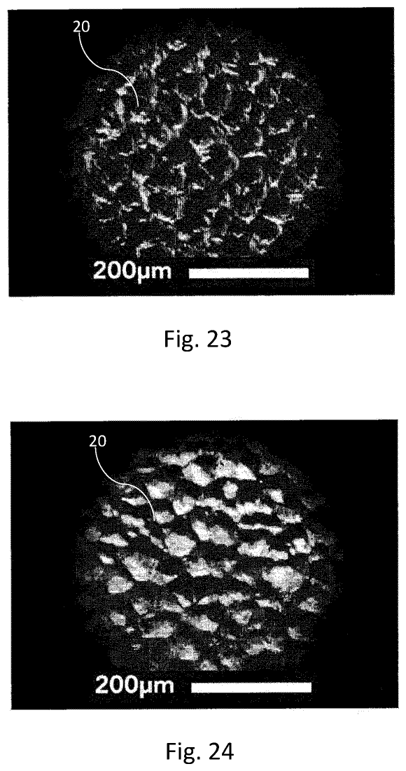

FIG. 23 shows a microscopic image of a diffuser surface 14. The diffuser surface 14 has been treated with a liquid or paste etchant to form cavities. The cavities have different shapes and different depths as well as different expansions. The largest extension of the individual cavities is less than 100 μm. The depth of the cavities is in the range of less than 30 μm. With such a surface, the light is optimally scattered and no shadows are created.

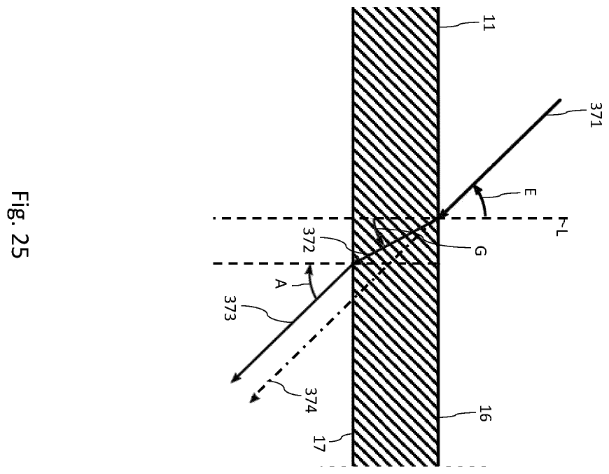

FIG. 24 corresponds to a diffuser surface 14 as shown in FIG. 23 in a second photograph.

FIG. 25 shows a schematic double refraction of a light beam 371, 372, 373 of a main axis of a light beam of a light source at a cross section of the illumination area 11. A perpendicular axis L is perpendicular to a longitudinal axis of the illumination area 11. The incident light beam 371 is inclined at an angle of incidence E relative to the perpendicular axis L and is refracted towards the perpendicular axis L when entering an inner surface 16 of the illumination area 11, which is made of glass and thus has a higher refractive index than air. The refracted light beam 372 thus has a smaller angle G with respect to the perpendicular axis L. However, when exiting from an outer side 17 of the illumination area 11, the outgoing light beam 373 again has an angle of incidence A with respect to the plumb axis L, which corresponds to the angle of incidence E. Thus, the outgoing light beam 373 is offset relative to a theoretical light beam 374 without refraction through the illumination area 11.

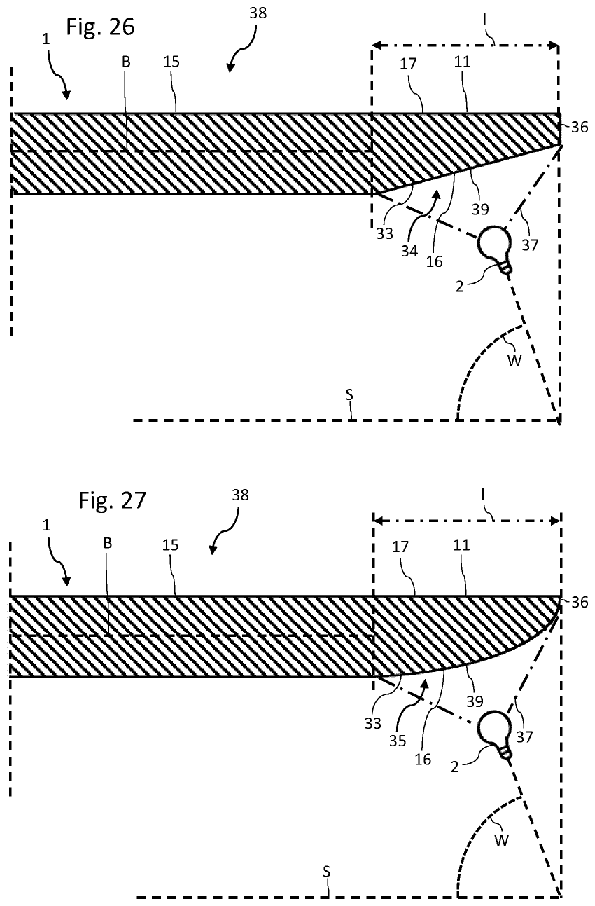

Thus, an optical grind arranged on the entrance side on an inner surface 16 of the illumination area 11, such as a prism, can increase the brightness in an area directly in front of a viewing area (see FIG. 26 and FIG. 27).

FIGS. 26 and 27 show a cross-section of two embodiments of the mirror surface 1 of a mirror device with an optical grind 33 on an inner surface 16 of an illumination area 11 facing a light source 2. The mirror surface 1 has a viewing area 15 that reflects light from the front and is opaque to light from the rear. In contrast, the illumination area 11 of the mirror surface 1 is at least partially translucent and is made of quartz glass. The optical grind 33 in FIG. 26 has a facet-ground shape 34 that extends in a straight line inclined relative to a longitudinal axis B of the viewing area 15 to an edge 36 of the viewing area 11. The edge 36 in FIG. 26 forms a surface perpendicular to the longitudinal axis B of the viewing area 15 so that there is no sharp edge at the edge 36 of the optical grind 33. The length 1 from the viewing area 15 to the edge 36 of the optical grind 33 is 20 mm. The width of the glass pane of the illumination area 11 is 4 mm. The width of the optical grind 33 is only 2 mm, but has not been shown to scale in FIG. 26 for clarity. The resulting angle of inclination of the optical grind in FIG. 26 is thus about 6°.

The optical grind 33 in FIG. 27, on the other hand, has a smooth-ground shape 35, which runs convexly adjacent to the viewing area 15 to the edge 36 of the illumination area 11. Thus, the outgoing light beams of a light beam 37 are directed to an area 38 close in front of the viewing area 15 (see FIG. 25). The light source 2 in FIG. 26 and FIG. 27 is oriented so that the light beams of the light beam 37 impinge substantially perpendicularly on an entrance region 39 of the optical grind 33. For this purpose, the light source 2 is arranged at an inclination angle W relative to that of an axis S of the mirror surface 1. The major axis of the light beams 37 is oriented to illuminate the entire optical grind 33 of the illumination area 11. However, an even steeper arrangement of the main axis of the light beam 37 by a mirror perpendicular to the longitudinal axis of the viewing area 15 at the outer edge 36 would be conceivable. Opposite the inner surface 16 of the illumination area 11, an outer side 17 is arranged which runs parallel to the longitudinal axis B and is materially adjacent to the viewing area 15.

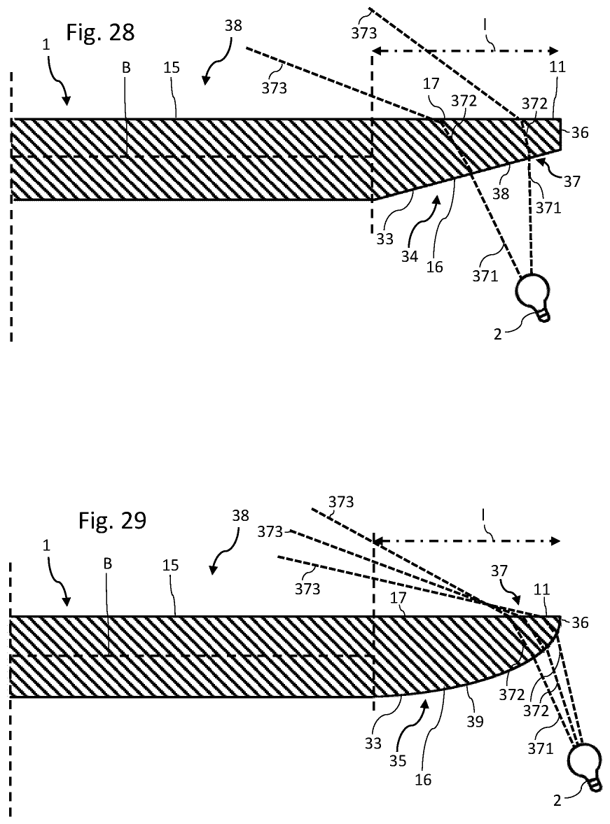

FIGS. 28 and 29 show a cross-section of the mirror surface 1 of the mirror device according to FIGS. 26 and 27 with the schematic light beams 371, 372, 373 of a light beam 37. The light source 2 was arranged offset to FIG. 26 and FIG. 27 for better illustration of the effect. Due to the optical grind 33, in both FIG. 28 and FIG. 29, the incident light beams 371 are refracted by entering the entrance area 39 and exiting the outer side 17 of the illumination area 11.

When the incident light beam 371 enters the illumination area 11 made of glass from the thinner medium air, the light beam 372 is refracted toward the perpendicular axis of the interface. On the other hand, as the light beam 373 exits the outer side 17, it is refracted away from the perpendicular axis (see FIG. 25).

The arrangement of the optical grind 33 thus allows the outgoing light rays 373 to be refracted toward the viewing area 15, providing a user with better illumination in the area 38 near the front of the mirror surface 1.

This effect can be achieved either by the facet-cut shape 34 or the smooth-cut shape of the optical grind 33 on the inner surface 16 of the illumination area 11. The outer side 17, on the other hand, runs parallel to the longitudinal axis B of the viewing area 15 and does not have a ground finish. In addition, when arranging the light source 2 relative to the optical grind 33, the angle of total reflection of the glass used, such as crown glass or flint glass, for the illumination area 11 relative to the optically thinner medium air can be taken into account to optimize the illumination effect. In FIG. 29, the incident light rays 371 that strike the optical grind 33 further out in the direction of the edge 36, and thus have a shallower larger angle to the perpendicular axis of the entrance area 39, are refracted more strongly toward the viewing area 15 in front of the mirror surface 1 when the light rays 373 exit. Due to this effect, the outgoing light rays 373 in FIG. 29 overlap through the smooth-ground shape 35 in an area in front of the mirror surface 1.

1. A mirror device comprising a mirror surface with a viewing area and an illumination area and at least one light source,
wherein
the at least one light source is arranged behind the illumination area of the mirror surface
wherein
the viewing area is substantially opaque to the area behind the mirror surface and
the illumination area comprises an inner surface and an outer side,
wherein
the inner surface is arranged on the side of the illumination area facing the light source and the outer side is formed on the side facing away from the light source,
wherein,
a main axis of a light beam of the light source is oriented at an angle of 3° to 89°, at an angle of 45° to 87°, or 75° to 85°, relative to a mirror plane of the mirror surface oriented toward the viewing area.

2. The mirror device according to claim 1, wherein said
illumination area comprises
an optical grind on said inner surface
and
the optical grind extends adjacent to the viewing area up to an outer edge of the mirror surface.

3. A mirror device comprising a mirror surface, at least one light source, a control device connected to the light source, and a first control element and second control element, wherein the first and the second control element are connected to the control device via a cable, wherein the light source is operable by the first control element and the second control element,
wherein
a first illumination mode of the light source can be switched on and off by the first control element and the second illumination mode of the light source can be switched on and off by the second control element
wherein
the first illumination mode is a night light mode and has a lower blue light component than the second illumination mode, and the first illumination mode differs from the second illumination mode.

4. The mirror device according to claim 3, wherein the control device comprises an operating element for adjusting the intensity and/or color temperature of the light source of the first illumination mode and/or second illumination mode
wherein the operating element is arranged behind the removable mirror surface.

5. The mirror device according to claim 4, wherein the color temperature of the light source is adjustable in a range from 500 K to 10000 K.

6. The mirror device according to claim 3, wherein indirect illumination can be generated by the light source.

7. The mirror device according to claim 3, wherein the light source has a color temperature of at most 2600 K in the first illumination mode.

8. The mirror device according to claim 3, wherein in the first illumination mode a first light source can be switched on and off by the first control element and in the second illumination mode a second light source can be switched on and off by the second control element.

9. The mirror device according to claim 8, wherein the first light source of the first illumination mode is arranged on the underside of the mirror device.

10. The mirror device according to claim 3, wherein the mirror device comprises a cabinet body and the mirror surface is at least partially movably arranged.

11. A method of manufacturing a mirror device according to claim 3, comprising the following step:
connecting the first control element and the second control element to the control device via a cable, so that at least one light source can be switched on and off by the first control element and by the second control element.

12. A mirror device comprising a mirror surface, a control device and a light source, wherein
a capacitive sensor is formed, with which the intensity and/or color temperature of the light source can be controlled in such a way that the light intensity and/or color temperature can be adjusted by approaching and/or touching a user.

13. The mirror device according to claim 12, wherein the capacitive sensor is arranged at/in an edge of the mirror device.

14. The mirror device according to claim 12, wherein the capacitive sensor is arranged below the mirror surface, such that the capacitive sensor is controllable by a proximity and/or touch of a user on the mirror surface.

15. A method of manufacturing a mirror device according to claim 12, comprising the following step:
connecting a capacitive sensor to the light source such that the intensity of the light source is adjustable by the proximity and/or touch of a user.

16. The mirror device according to claim 12, wherein the mirror surface comprises a viewing area and an illumination area, and the light source is arranged behind the illumination area of the mirror surface
wherein the viewing area is substantially opaque to the area behind the mirror surface
and the illumination area comprises an inner surface and an outer side
wherein the inner surface is arranged on the side of the illumination area facing the light source and the outer side is formed on the side facing away from the light source.
wherein the inner surface comprises an interference optical coating.

17. The mirror device according to claim 16, wherein the illumination area comprises a diffuser surface on the outer side of the illumination area.

18. A method of manufacturing a mirror device according to claim 16, comprising:
applying the interference optical coating on the inner surface of the illumination area.

19. (canceled)

20. The mirror device according to claim 4, wherein the operating element comprises a rotary switch.

21. The mirror device according to claim 1, wherein the inner surface comprises at least an interference optical coating or a diffuser surface on the outer side of the illumination area.

22. A method of manufacturing a mirror device according to claim 17, comprising:
applying the interference optical coating on the inner surface of the illumination area
